(19) United States
(12) Patent Application Publication
(10) Pub. No.: US 2026/0299140 A1
(43) Pub. Date: Oct. 1, 2026

(54) SYSTEMS AND METHODS FOR PRECISE LOCATION DETERMINATION FOR A USER EQUIPMENT

(71) Applicant: Verizon Patent and Licensing Inc., Basking Ridge, NJ (US)

(72) Inventors: Sumanth S. Mallya, Flower Mound, TX (US); Christopher N. DelRegno, Rowlett, TX (US); Eric M. Flattum, Bolingbrook, IL (US); Madhu Naveenkumar, Bangalore (IN); Suman Das, Kolkata (IN)

(73) Assignee: Verizon Patent and Licensing Inc., Basking Ridge, NJ (US)

(21) Appl. No.: 19/215,725

(22) Filed: May 22, 2025

(30) Foreign Application Priority Data
Mar. 28, 2025 (IN) 202541029853

(51) Int. Cl. G01S 19/47; G01S 19/39

(52) U.S. Cl. CPC G01S 19/47; G01S 19/393

(57) ABSTRACT

A system described herein may receive a set of signals from a plurality of satellites; determine a first set of pseudoranges based on the received set of signals; determine a coarse location for each pseudorange, of the first set of pseudoranges; determine a set of correction values for each pseudorange, of the first set of pseudoranges, based on the coarse location; apply the set of correction values to the first set of pseudoranges to obtain a second set of pseudoranges; determine, based on one or more artificial intelligence/machine learning (“AI/ML”) models, a third set of pseudoranges based on the second set of pseudoranges; identify a set of sensor data associated with the device; modify the third set of pseudoranges based on the sensor data to obtain a fourth set of pseudoranges; and determine a precise location of the device based on the fourth set of pseudoranges.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. UEs may utilize techniques such as Global Positioning System (“GPS”) or Global Navigation Satellite System (“GNSS”)-based techniques to locally determine UE location. For example, a UE may detect signals from one or more GPS satellites, and may compute or estimate a distance of the UE from each respective GPS satellite (where such distance is sometimes referred to as a “pseudorange”). The location of the UE may be triangulated based on multiple pseudoranges between the UE and multiple GPS satellites at a given time. Factors such as topographical features (e.g., mountains, buildings, valleys, etc.), ionospheric interference, tropospheric interference, radio noise, or other factors may reduce the accuracy of identifying pseudoranges, and may therefore result in multipath errors and/or the increased possible range of locations (e.g., a larger possible location radius) for the UE.

### BRIEF DESCRIPTION OF THE DRAWINGS

FIG. 1 illustrates an example overview of one or more embodiments described herein;

FIG. 2 illustrates an example of performing location-based pseudorange corrections, in accordance with some embodiments;

FIG. 3 illustrates an example of refining a set of pseudoranges, in accordance with some embodiments;

FIG. 4 illustrates an example of applying UE sensor data to pseudoranges, in accordance with some embodiments;

FIG. 5 illustrates an example process for computing a precise UE location, in accordance with some embodiments;

FIGS. 6 and 7 illustrate example environments in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for enhanced precision location techniques for devices, such as UEs that communicate with a wireless network. Specifically, for example, techniques in accordance with embodiments described herein provide for an enhanced location determination that is based on satellite-based location determination techniques (e.g., GPS-based techniques, GNSS-based techniques, etc.). For example, as discussed below, a UE may compute pseudoranges between the UE and one or more satellites (e.g., GPS satellites, GNSS satellites, etc.), and may further refine the pseudorange information based on techniques such as location-based pseudorange corrections, artificial intelligence/machine learning (“AI/ML”) pseudorange refinement (e.g., in which sets of measured pseudoranges are refined to pseudoranges determined based on a training or learning operation), and smoothing or filtering based on internal UE sensor data (e.g., to eliminate location determination errors that may result from activities such as walking with a phone in a user's pocket, a user bouncing a phone up and down, or otherwise moving the phone while the user remains stationary). The techniques described herein may therefore enhance the accuracy and precision of the determination of the location of a UE, which may enhance technologies such as device-based navigation, in which wireless signals (e.g., satellite signals) are used to determine the location of a UE and to provide real-time navigation directions based on the current location of the UE.

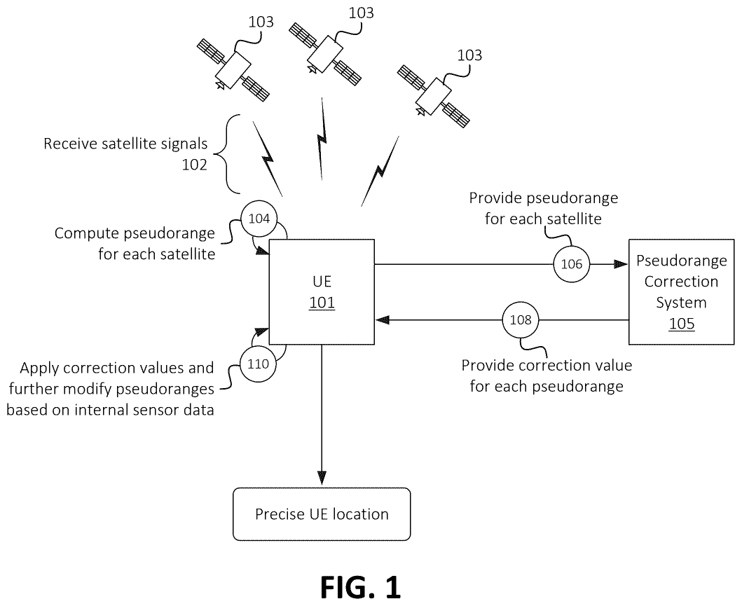

As shown in FIG. 1, for example, UE 101 may receive or otherwise detect (at 102) signals from one or more satellites 103 (e.g., GNSS satellites, GPS satellites, etc.). The signals may include, for example, timing information (e.g., an indication of a time at which a given signal was transmitted or broadcasted from a given satellite 103), identifier information (e.g., identifiers of one or more respective satellites 103 that transmitted or broadcasted respective signals), ephemeris data (e.g., position and/or trajectory information of one or more satellites 103 that that transmitted or broadcasted respective signals), and/or other suitable information.

UE 101 may compute (at 104) a pseudorange for each satellite 103. For example, UE 101 may compute a distance between UE 101 and each respective satellite 103 based on information included in the wireless signals. Generally, for example, the pseudorange between UE 101 and a particular satellite 103 may be computed as a function of the time at which satellite 103 broadcasted a particular set of signals and the time at which UE 101 received the particular set of signals (e.g., the delay, travel time, transmission time, etc. of the particular set of signals).

UE 101 may further provide (at 106) the pseudorange information (as computed at 104) to Pseudorange Correction System (“PCS”) 105. PCS 105 may determine one or more correction values for each pseudorange. The correction values may indicate, for example, a distance offset to apply for each pseudorange (e.g., where a given correction value may specify that a particular pseudorange should be increased or decreased). In some embodiments, PCS 105 may maintain pseudorange correction values, for each satellite 103, based on the location (or approximate location) of a receiver of signals from each satellite 103. Thus, in some embodiments, PCS 105 may determine a coarse location of UE 101 based on the pseudoranges computed (at 104), and may identify correction values for each pseudorange based on the coarse location of UE 101. PCS 105 may provide (at 108) the correction values for each pseudorange to UE 101.

In some embodiments, as discussed below, PCS 105 and/or some other suitable device or system may perform further operations to further refine the corrected pseudoranges prior to providing such pseudoranges to UE 101. For example, PCS 105 and/or some other suitable device or system may perform AI/ML techniques, such as using one or more models (e.g., long-short term memory “LSTM”) models or other types of models) that have been trained on sets of pseudoranges, to provide refined pseudoranges. In one example situation, a group of UEs located at the edge of a lake may have computed pseudoranges that indicate that the locations of the UEs are (or are potentially) inside the lake. A particular AI/ML model, in accordance with some embodiments, may have been trained to eliminate the lake itself as a potential location for the UEs. As such, when given a set of pseudoranges that indicate a location within the lake, the AI/ML model may be used to modify or refine the set of pseudoranges to a different set of pseudoranges that is along the edge of the lake or is otherwise not inside the lake.

UE 101 may apply (at 110) the correction values to each pseudorange, and/or may refine or modify the pseudoranges based on modifications determined based on AI/ML techniques. UE 101 may further, in accordance with some embodiments, further modify the pseudoranges based on internal sensor data. For example, UE 101 may collect, monitor, etc. sensor data such as accelerometer data, Inertial Measurement Unit (“IMU”) data, altimeter data, barometer data, haptic sensor data, microphone (e.g., audio input) data, camera (e.g., video input) data, and/or other suitable sensor data. UE 101 may perform a filtering or smoothing operation (e.g., a Kalman filtering operation or some other suitable type of operation) in order to eliminate potential location determination errors introduced by factors such as UE movement in space (e.g., shuffling in a user's hands, bouncing in a user's pocket, etc.) without actual meaningful movement of UE 101 or a user of UE 101.

UE 101 may further compute a precise location of UE 101 based on some or all of the above techniques, which serve to enhance the precision and accuracy of the location determination of UE 101. For example, UE 101 may perform a triangulation technique or other suitable technique to compute or derive the precise location of UE 101 based on the pseudoranges that are modified, refined, processed, etc. using the techniques described herein.

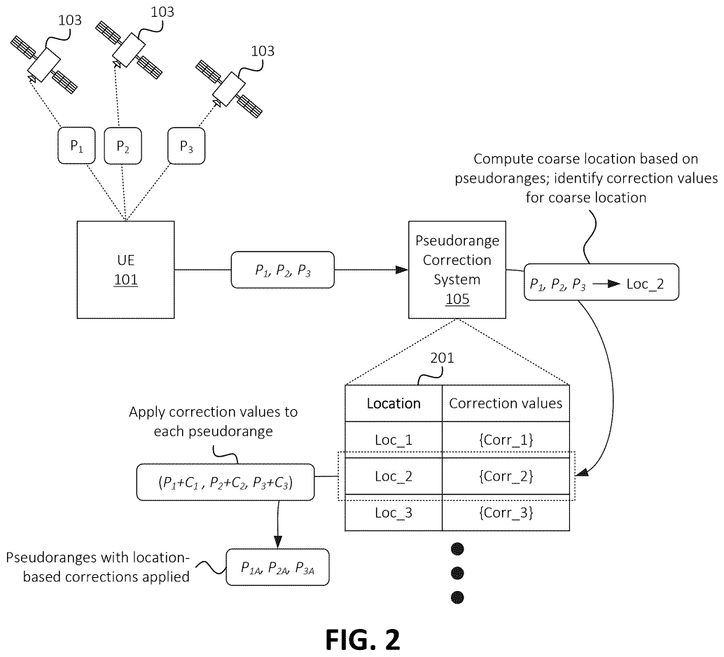

FIG. 2 illustrates an example of identifying coarse location-based pseudorange correction values, in accordance with some embodiments. Similar to concepts described above, a particular UE 101 may compute a set of pseudoranges associated with a set of satellites 103. UE 101 may, for example, compute the set of pseudoranges for satellites 103 based on signals received or detected from satellites 103 within a particular time window, such as within a 10-millisecond time window, a 100-millisecond time window, a one-second time window, or some other suitable time window. In this sense, the pseudoranges may be used to ultimately determine a location of UE 101 during such time window.

In this example, UE 101 computes three example pseudoranges, P₁, P₂, and P₃. Specifically, for example, P₁ may be a first pseudorange associated with a first satellite 103, P₂ may be a second pseudorange associated with a second satellite 103, and P₃ may be a third pseudorange associated with a third satellite 103. UE 101 may provide these pseudorange values P₁, P₂, and P₃ to PCS 105. PCS 105 may compute a coarse location on the pseudorange values. This location may be a “coarse” location, inasmuch as further operations may be performed, in accordance with some embodiments, to further refine (e.g., improve the precision of) the determined location of UE 101. For example, the coarse location may be determined by performing a triangulation operation, a weighted least squares (“WLS”) technique, or other suitable operation based on the received pseudorange information. In some embodiments, PCS 105 may utilize techniques such as Differential GPS (“DGPS”) techniques in order to increase the accuracy of the coarse location. In this example, the coarse location is represented as “Loc_2,” which may refer to a set of GPS coordinates, a set of latitude and longitude coordinates, and/or some other suitable representation of geographical location.

In some embodiments, PCS 105 may maintain data structure 201, and/or may otherwise maintain similar information, that includes sets of pseudorange correction values for different locations. For example, a first set of correction values {Corr_1} may correspond to a first location Loc_1, a second set of set of correction values {Corr_2} may correspond to a second location Loc_2, a third set of correction values {Corr_3} may correspond to a first location Loc_3, and so on. The sets of correction values for each location may include, for example, different correction value for different satellites 103. For example, the second set of correction values {Corr_2}, which correspond to Loc_2, may include a first correction value C₁, a second correction value C₂, and a third correction value C₃. The first correction value C₁ may be applicable to pseudorange values associated with the first satellite 103, the second correction value C₂ may be applicable to pseudorange values associated with the second satellite 103, and the third correction value C₃ may be applicable to pseudorange values associated with the third satellite 103. In other words, PCS 105 may maintain or identify a different correction value for each satellite 103, and for each coarse location.

PCS 105 may accordingly apply the respective correction values to each pseudorange. For example, as shown in FIG. 2, P₁+C₁ may represent the first correction value C₁ being applied to the first pseudorange P₁; P₂+C₂ may represent the second correction value C₂ being applied to the second pseudorange P₂; and P₃+C₃ may represent the third correction value C₃ being applied to the third pseudorange P₃. The resulting pseudoranges may be represented as P_{1A} (e.g., the result of applying the first correction value C₁ to the first pseudorange P₁), P_{2A}, and P_{3A}.

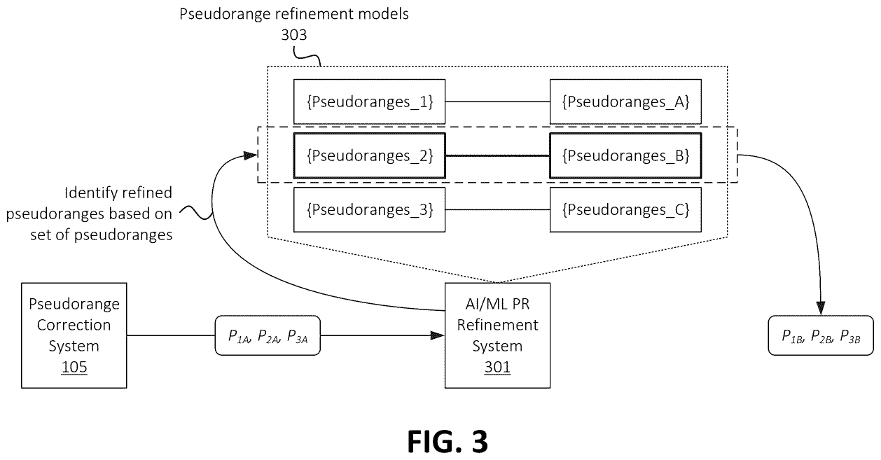

In some embodiments, as shown in FIG. 3, AI/ML techniques may be used to further refine the corrected pseudoranges. For example, PCS 105 may provide the corrected pseudoranges P_{1A}, P_{2A}, and P_{3A} to AI/ML Pseudorange Refinement System (“APRS”) 301. In some embodiments, APRS 301 may be implemented as a separate device or system from PCS 105 (e.g., PCS 105 and APRS 301 may be communicatively coupled to a network or some other suitable communication pathway). In some embodiments, some or all of the functionality described with respect to APRS 301 may be performed by PCS 105.

APRS 301 may maintain one or more pseudorange refinement models 303, which may associate particular sets of pseudoranges (e.g., “input” sets of pseudoranges such as a {Pseudoranges_1}, {Pseudoranges_2}, {Pseudoranges_3}, and so on) with respective sets of refined pseudoranges (e.g., “output” sets of pseudoranges such as {Pseudoranges_A}, {Pseudoranges_B}, {Pseudoranges_C}, and so on). For example, APRS 301 and/or some other suitable device or system may perform an AI/ML training operation, an AI/ML learning operation, and/or some other suitable AI/ML operation in order to generate or refine pseudorange refinement models 303. In one example, training pseudorange refinement models 303 may include receiving sets of input pseudoranges associated with one or more UEs 101, and receiving or determining an actual location of such UEs 101. For example, the actual location may be determined using techniques other than, or in addition to, GPS techniques. In this manner, the “true” or actual location of such UEs 101 may be able to be determined. In situations where the reported pseudoranges (e.g., input pseudoranges) for these UEs 101 indicate a location that is different from the actual location, the output pseudoranges may be adjusted to match or otherwise meet the true or actual location. In this manner, when given a particular set of input pseudoranges, APRS 301 may be able to identify a refined set of pseudoranges (e.g., a corresponding set of output pseudoranges).

APRS 301 may identify that the received set of pseudoranges (e.g., the set of corrected pseudoranges P_{1A}, P_{2A}, and P_{3A}) matches, meets, satisfies, etc. a particular set of input pseudoranges associated with a particular pseudorange refinement model 303. For example, APRS 301 may utilize AI/ML techniques, perform a similarity analysis, and/or employee another suitable technique in order to select a particular set of input pseudoranges based on the received set of pseudoranges. In this example, APRS 301 identifies that the received set of pseudoranges matches the example set of input pseudoranges {Pseudoranges_2}. APRS 301 may further identify that one or more pseudorange refinement models 303 indicate that {Pseudoranges_B} is a set of output pseudoranges with which {Pseudoranges_2} is associated with, correlated, etc. (e.g., based on one or more AI/ML training, learning, etc. operations, as discussed above). In this example, {Pseudoranges_B} includes refined pseudoranges P_{1B}, P_{2B}, and P_{3B}. For example, P_{1B} may represent a first pseudorange P₁, associated with a first satellite 103, after a location-based correction has been applied and as well as a refinement of the set of pseudoranges that include or are based on the first pseudorange.

In some embodiments, different sets of input pseudoranges may be associated with particular satellites 103 (e.g., where pseudorange information may include an identifier of, or otherwise indicate, a particular satellite 103 with which such a given pseudorange is associated with). In some embodiments, different sets of input pseudoranges may be associated with different attributes or information, in addition to or in lieu of identifiers of satellites 103 with which pseudoranges are associated. For example, in some embodiments, different sets of input pseudoranges may include attributes of pseudoranges, such as proximity of pseudoranges to each other in a given set of pseudoranges, a geographical region with which a given set of pseudoranges is associated, device attributes (e.g., make, model, type, location, trajectory, and/or other attributes) of UE 101 that computed a given set of pseudoranges. In some embodiments, different sets of input pseudoranges may include other types of conditions or criteria based on which APRS 301 may evaluate sets of pseudoranges (e.g., as received from PCS 105) to select a corresponding input set of pseudoranges and, ultimately, a corresponding output set of pseudoranges.

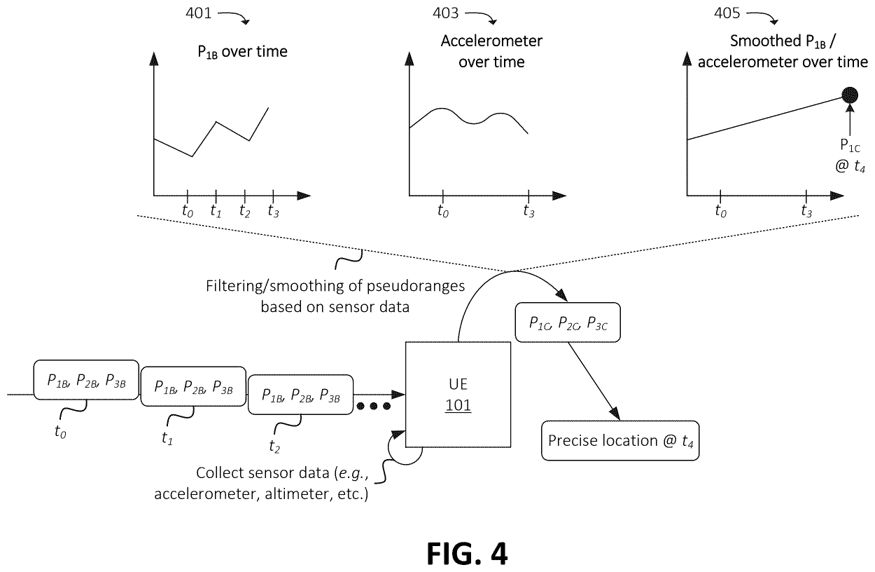

As discussed above, and as shown in FIG. 4, UE 101 may perform further smoothing, filtering, etc. of pseudoranges based on sensor data associated with UE 101. For example, in some embodiments, UE 101 may receive sets of corrected and/or refined set of pseudoranges (e.g., P_{1A}, P_{2A}, and P_{3A} and/or P_{1B}, P_{2B}, and P_{3B}) from PCS 105 and/or from APRS 301. That is, while some embodiments are described in the context of pseudorange smoothing and/or filtering with respect to pseudoranges that have been corrected using location-based pseudorange corrections as well as pseudoranges that have been refined using AI/ML techniques (e.g., P_{1B}, P_{2B}, and P_{3B}), similar concepts may be used to perform pseudorange smoothing and/or filtering with respect to pseudoranges that have not been refined using AI/ML techniques (e.g., pseudoranges that have been corrected using location-based pseudorange corrections, such as P_{1A}, P_{2A}, and P_{3A}).

In some embodiments, UE 101 may receive pseudorange information over time. As such, UE 101 may receive or determine a first set of pseudoranges (e.g., associated with a particular set of satellites 103) over a first timeframe t₀, a second set of pseudoranges (e.g., associated with the same particular set of satellites 103) over a second timeframe t₁, a third set of pseudoranges over a third timeframe t₂, and so on. UE 101 may also collect sensor data (e.g., sensor data corresponding to timeframes t₀, t₁, t₂, etc., and/or timeframes that include or otherwise represent timeframes t₀, t₁, t₂, etc.).

UE 101 may perform a smoothing operation, a filtering operation, etc. using the set of pseudoranges as well as the collected sensor data over time. In this example, graph 401 may represent a particular pseudorange value (e.g., a particular corrected and/or refined pseudorange value P_{1B}) over a particular duration of time, such as one second, 10 seconds, one minute, etc. In this example, the particular duration of time includes pseudorange values that are associated with time windows t₀ through t₃.

Graph 403 may represent a sensor data collected by UE over the same particular duration of time. In some example scenarios, the sensor data may include values that correspond to the same particular timeframes t₀ through t₃. In practice, the sensor data may be collected more frequently (e.g., may include more data points or values than values associated with four timeframes) or less frequently (e.g., may include fewer data points or values than values associated with four timeframes).

Graph 405 may represent an example of the result of performing a filtering (e.g., Kalman filtering) operation, a smoothing operation, and/or some other operation based on the information depicted in graph 401 (e.g., pseudorange values for a particular satellite 103 over the particular duration of time, such as corrected and/or refined pseudorange values P_{1B}) and the information depicted in graph 403 (e.g., UE sensor data). In this example, the smoothed and/or filtered pseudorange and/or sensor data may indicate a relatively linear increase in the pseudorange associated with a particular satellite 103 and UE 101 (e.g., UE may be steadily moving farther away from satellite 103), despite the seemingly sporadic pseudorange values for this satellite 103 as indicated by graph 401. For example, a user of UE 101 may have been tossing UE 101 up and down while the user walks in a direction and speed whereby the distance between the user and satellite 103 steadily increases.

The smoothing and/or filtering may be used to predict, identify, compute, etc. a pseudorange value corresponding to a subsequent or later timeframe (e.g., at timeframe t₄). In this example, the predicted, identified, computed, etc. pseudorange value is represented as P_{1C}. For example, P_{1C} may be a value determined based on pseudorange values for a particular satellite 103 over time (e.g., different values for pseudorange P₁ over time, different values for corrected pseudorange P_{1A} over time, different values for corrected/refined pseudorange P_{1B} over time, etc.) as well as based on sensor data collected by UE 101 over the same period of time. For example, using AI/ML techniques (e.g., an LSTM model or other types of model), UE 101 and/or some other suitable device or system (e.g., PCS 105) may identify, based on previous pseudorange values and/or sensor data, a subsequent pseudorange value that accounts for (e.g., eliminates the effects of) local motion of UE 101 (e.g., UE 101 being physically moved, shuffled, manipulated, etc.), where such local motion may be reflected by the sensor data of UE 101.

UE 101 may further identify a precise location of UE 101 (e.g., at timeframe t₄, which may be a “present” timeframe or otherwise a more recent timeframe than timeframes t₀ through t₃). For example, UE 101 may compute its precise location based on smoothed and/or filtered pseudoranges associated with multiple satellites 103 (e.g., P_{1C} associated with a first satellite 103, P_{2C} associated with a second satellite 103, P_{3C} associated with a third satellite 103, and so on), such as by using triangulation techniques, WLS techniques, and/or other suitable techniques.

In some embodiments, one or more of the techniques described above may be performed in different sequences, and/or may be performed multiple times in order to compute the precise location of UE 101. That is, while the above examples describe operations performed in a particular sequence; namely (a) the computation of pseudoranges (e.g., P₁ through P₃), (b) a location-based correction of the pseudoranges (e.g., computing P_{1A} through P_{3A}), (c) an AI/ML refinement of the corrected pseudoranges (e.g., computing P_{1B} through P_{3B}), (d) a smoothing and/or filtering operation based on sensor data and the refined pseudoranges (e.g., computing P_{1C} through P_{3C}), one or more of these operations may be performed in a different sequence, and/or may be performed multiple times.

For example, in one example embodiment, and referring back to FIG. 1, UE 101 may perform a smoothing and/or filtering operation (e.g., a Kalman filtering operation) on raw pseudoranges computed based on received satellite signals (e.g., may perform such smoothing or filtering on P₁ values associated with a first satellite 103 over time, on P₂ values associated with a second satellite 103 over time, etc.). For example, UE 101 may utilize a filtering or smoothing operation based on previously computed (at 104) pseudoranges (e.g., as computed by UE 101) to determine “present” or subsequent pseudorange values, prior to providing (at 106) such pseudorange information to PCS 105. This filtering or smoothing operation may be performed in addition to, or in lieu of, the filtering or smoothing operation that is based on sensor data (e.g., as discussed above with respect to FIG. 4).

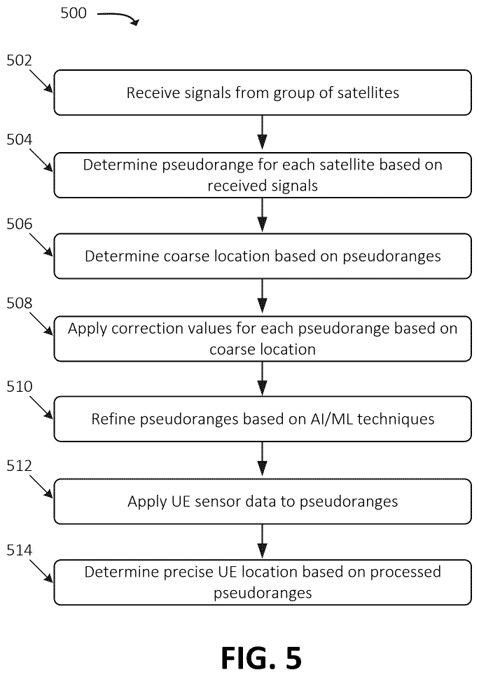

FIG. 5 illustrates an example process 500 for computing a precise UE location using techniques described herein. In some embodiments, some or all of process 500 may be performed by UE 101, PCS 105, APRS 301, and/or some other suitable device or system.

As shown, process 500 may include receiving (at 502) signals from a group of satellites 103. For example, as discussed above, UE 101 may receive, detect, etc. signals such as GPS signals, GNSS signals, etc. from satellites 103, which may broadcast such signals to aid in location determine for devices that include receivers or other suitable hardware that is able to receive or detect such signals. As discussed above, the signals may include information such as transmission time, satellite identifier information, or other suitable information.

Process 500 may further include determining (at 504) a respective pseudorange for each satellite 103 based on the received signals. For example, UE 101 may compute a transmission time, delay, travel time, etc. for signals from each satellite 103 based on a time of receiving signals from respective satellites 103 as well as a time of transmission of such signals. In some embodiments, UE 101 may further compute a distance (e.g., pseudorange) between UE 101 and each satellite 103 based on the computed transmission time, delay, etc. As discussed above, UE 101 may, in some embodiments, perform a smoothing or filtering operation on the pseudoranges (e.g., based on previous pseudoranges associated with the same satellites 103 in order to determine a current or subsequent pseudorange).

Process 500 may additionally include determining (at 506) a coarse location of UE 101 based on the pseudoranges. For example, UE 101 may utilize a WLS technique, a triangulation technique, or some other suitable technique in order to determine the coarse location. Additionally, or alternatively, UE 101 may provide the pseudorange information to another device or system, such as PCS 105, which may determine the coarse location of UE 101.

Process 500 may also include applying (at 508) correction values for each pseudorange based on the coarse location of UE 101. For example, as discussed above, PCS 105 may determine or provide correction for each pseudorange, associated with each satellite 103, based on the coarse location of UE 101.

Process 500 may further include refining (at 510) the pseudoranges based on AI/ML techniques. For example, as discussed above, UE 101 and/or some other device or system (e.g., APRS 301) may receive or identify the set of pseudoranges (e.g., as computed by UE 101 and/or as corrected using coarse location-based correction values), and may identify a refined set of pseudoranges (e.g., using an LSTM model and/or some other suitable type of model). As discussed above, the models may have been trained with a set of output pseudoranges, based on a training operation in which the actual or “true” location with respect to a set of input pseudoranges is known. Such techniques may be used to rectify reproducible location determination errors, such as errors caused by the presence of buildings, topographical features, or the like. In some embodiments, the models may be trained or otherwise based on location features such as lakes, roadways, or the like (e.g., as determined based on Geographic Information System (“GIS”) information or other geographical information), where using such models may eliminate potentially erratic input pseudoranges such as pseudoranges that indicate that a user is located in the middle of a lake, in the middle of a busy highway, etc.

Process 500 may additionally include applying (at 512) UE sensor data to the pseudoranges. For example, as discussed above, UE 101 may determine or collect sensor data, such as IMU data, accelerometer data, altimeter data, etc. The sensor data may be useful in “static motion” scenarios, in which UE 101 (or a user of UE 101) is not actually moving (e.g., walking, driving or riding in a vehicle, etc.) but in which UE 101 is experiencing some type of motion, such as being tossed up and down, shuffled or manipulated in a user's hand, being located in a user's pocket, etc. UE 101 may apply or filter one or more pseudoranges based on the sensor data, where such filtering may reduce or eliminate pseudorange fluctuations or variations that are introduced by the static motion of UE 101.

Process 500 may also include determining (at 514) a precise UE location based on the processed pseudoranges. For example, UE 101 may perform a WLS technique, a triangulation technique, or some other suitable technique based on the pseudoranges that have been processed using some or all of the techniques described above. In this manner, the determined location of UE 101 may be significantly improved, both in terms of precision and accuracy, as compared to implementations that rely on pseudorange values alone (e.g., implementations that utilize the coarse location as the location of UE 101). UE 101 may accordingly use the precise location of UE 101 in a variety of applications or services, such as in a real-time turn-by-turn navigation service, a “lost phone” service, a location tracking service, or the like.

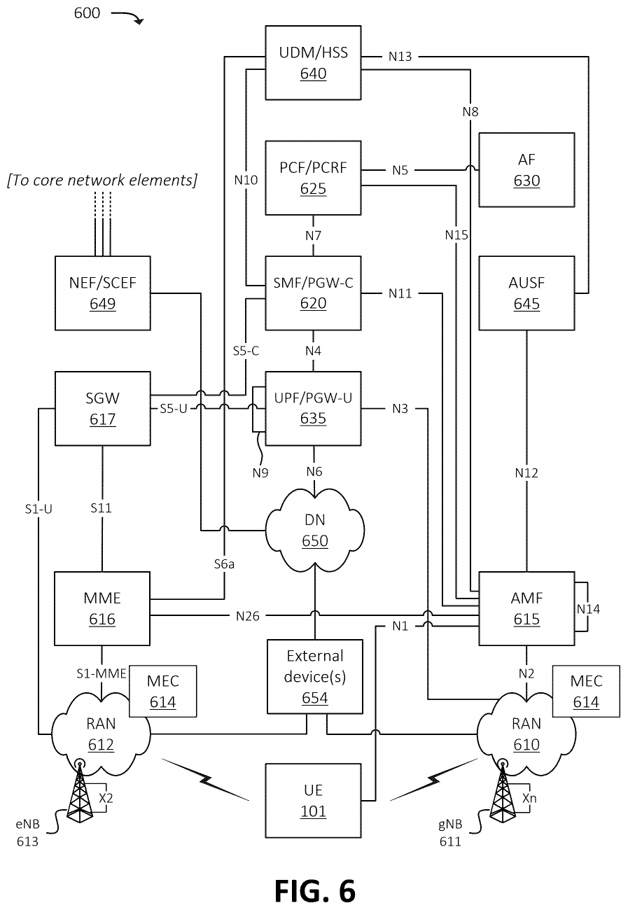

FIG. 6 illustrates an example environment 600, in which one or more embodiments may be implemented. In some embodiments, environment 600 may correspond to a Fifth Generation (“5G”) network, and/or may include elements of a 5G network. In some embodiments, environment 600 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 600 may represent or may include a 5G core (“5GC”). As shown, environment 600 may include UE 101, RAN 610 (which may include one or more Next Generation Node Bs (“gNBs”) 611), RAN 612 (which may include one or more evolved Node Bs (“eNBs”) 613), and various network functions such as Access and Mobility Management Function (“AMF”) 615, Mobility Management Entity (“MME”) 616, Serving Gateway (“SGW”) 617, Session Management Function (“SMF”)/Packet Data Network (“PDN”) Gateway (“PGW”)-Control plane function (“PGW-C”) 620, Policy Control Function (“PCF”)/Policy Charging and Rules Function (“PCRF”) 625, Application Function (“AF”) 630, User Plane Function (“UPF”)/PGW-User plane function (“PGW-U”) 635, Unified Data Management (“UDM”)/Home Subscriber Server (“HSS”) 640, Authentication Server Function (“AUSF”) 645, and Network Exposure Function (“NEF”)/Service Capability Exposure Function (“SCEF”) 649. Environment 600 may also include one or more networks, such as Data Network (“DN”) 650. Environment 600 may include one or more additional devices or systems communicatively coupled to one or more networks (e.g., DN 650), such as one or more external devices 654.

The example shown in FIG. 6 illustrates one instance of each network component or function (e.g., one instance of SMF/PGW-C 620, PCF/PCRF 625, UPF/PGW-U 635, UDM/HSS 640, and/or AUSF 645). In practice, environment 600 may include multiple instances of such components or functions. For example, in some embodiments, environment 600 may include multiple “slices” of a core network, where each slice includes a discrete and/or logical set of network functions (e.g., one slice may include a first instance of AMF 615, SMF/PGW-C 620, PCF/PCRF 625, and/or UPF/PGW-U 635, while another slice may include a second instance of AMF 615, SMF/PGW-C 620, PCF/PCRF 625, and/or UPF/PGW-U 635). The different slices may provide differentiated levels of service, such as service in accordance with different Quality of Service (“QoS”) parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Additionally, one or more elements of environment 600 may be implemented in a virtualized and/or containerized manner. For example, one or more of the elements of environment 600 may be implemented by one or more Virtualized Network Functions (“VNFs”), Cloud-Native Network Functions (“CNFs”), etc. In such embodiments, environment 600 may include, may implement, and/or may be communicatively coupled to an orchestration platform that provisions hardware resources, installs containers or applications, performs load balancing, and/or otherwise manages the deployment of such elements of environment 600. In some embodiments, such orchestration and/or management of such elements of environment 600 may be performed by, or in conjunction with, the open-source Kubernetes® application programming interface (“API”) or some other suitable virtualization, containerization, and/or orchestration system.

Elements of environment 600 may interconnect with each other and/or other devices via wired connections, wireless connections, or a combination of wired and wireless connections. Examples of interfaces or communication pathways between the elements of environment 600, as shown in FIG. 6, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 6, such as Service-Based Interfaces (“SBIs”), including an Namf interface, an Nudm interface, an Npcf interface, an Nupf interface, an Nnef interface, an Nsmf interface, and/or one or more other SBIs.

UE 101 may include a computation and communication device, such as a wireless mobile communication device that is capable of communicating with RAN 610, RAN 612, and/or DN 650. UE 101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 101 may send traffic to and/or receive traffic (e.g., user plane traffic) from DN 650 via RAN 610, RAN 612, and/or UPF/PGW-U 635.

RAN 610 may be, or may include, a 5G RAN that implements a 5G RAT and that includes one or more base stations (e.g., one or more gNBs 611), via which UE 101 may communicate with one or more other elements of environment 600. UE 101 may communicate with RAN 610 via an air interface (e.g., as provided by gNB 611). For instance, RAN 610 may receive traffic (e.g., user plane traffic such as voice call traffic, data traffic, messaging traffic, etc.) from UE 101 via the air interface, and may communicate the traffic to UPF/PGW-U 635 and/or one or more other devices or networks. Further, RAN 610 may receive signaling traffic, control plane traffic, etc. from UE 101 via the air interface, and may communicate such signaling traffic, control plane traffic, etc. to AMF 615 and/or one or more other devices or networks. Additionally, RAN 610 may receive traffic intended for UE 101 (e.g., from UPF/PGW-U 635, AMF 615, and/or one or more other devices or networks) and may communicate the traffic to UE 101 via the air interface.

RAN 612 may be, or may include, an LTE RAN that implements an LTE RAT and that includes one or more base stations (e.g., one or more eNBs 613), via which UE 101 may communicate with one or more other elements of environment 600. UE 101 may communicate with RAN 612 via an air interface (e.g., as provided by eNB 613). For instance, RAN 612 may receive traffic (e.g., user plane traffic such as voice call traffic, data traffic, messaging traffic, signaling traffic, etc.) from UE 101 via the air interface, and may communicate the traffic to UPF/PGW-U 635 (e.g., via SGW 617) and/or one or more other devices or networks. Further, RAN 612 may receive signaling traffic, control plane traffic, etc. from UE 101 via the air interface, and may communicate such signaling traffic, control plane traffic, etc. to MME 616 and/or one or more other devices or networks. Additionally, RAN 612 may receive traffic intended for UE 101 (e.g., from UPF/PGW-U 635, MME 616, SGW 617, and/or one or more other devices or networks) and may communicate the traffic to UE 101 via the air interface.

One or more RANs of environment 600 (e.g., RAN 610 and/or RAN 612) may include, may implement, and/or may otherwise be communicatively coupled to one or more edge computing devices, such as one or more Multi-Access/Mobile Edge Computing (“MEC”) devices (referred to sometimes herein simply as a “MECs”) 614. MECs 614 may be co-located with wireless network infrastructure equipment of RANs 610 and/or 612 (e.g., one or more gNBs 611 and/or one or more eNBs 613, respectively). Additionally, or alternatively, MECs 614 may otherwise be associated with geographical regions (e.g., coverage areas) of wireless network infrastructure equipment of RANs 610 and/or 612. In some embodiments, one or more MECs 614 may be implemented by the same set of hardware resources, the same set of devices, etc. that implement wireless network infrastructure equipment of RANs 610 and/or 612. In some embodiments, one or more MECs 614 may be implemented by different hardware resources, a different set of devices, etc. from hardware resources or devices that implement wireless network infrastructure equipment of RANs 610 and/or 612. In some embodiments, MECs 614 may be communicatively coupled to wireless network infrastructure equipment of RANs 610 and/or 612 (e.g., via a high-speed and/or low-latency link such as a physical wired interface, a high-speed and/or low-latency wireless interface, or some other suitable communication pathway).

MECs 614 may include hardware resources (e.g., configurable or provisionable hardware resources) that may be configured to provide services and/or otherwise process traffic to and/or from UE 101, via RAN 610 and/or 612. For example, RAN 610 and/or 612 may route some traffic from UE 101 (e.g., traffic associated with one or more particular services, applications, application types, etc.) to a respective MEC 614 instead of to core network elements of 600 (e.g., UPF/PGW-U 635). MEC 614 may accordingly provide services to UE 101 by processing such traffic, performing one or more computations based on the received traffic, and providing traffic to UE 101 via RAN 610 and/or 612. MEC 614 may include, and/or may implement, some or all of the functionality described above with respect to UPF/PGW-U 635, AF 630, external devices 654, one or more application servers, and/or one or more other devices, systems, VNFs, CNFs, etc. In this manner, ultra-low latency services may be provided to UE 101, as traffic does not need to traverse links (e.g., backhaul links) between RAN 610 and/or 612 and the core network.

AMF 615 may include one or more devices, systems, VNFs, CNFs, etc., that perform operations to register UE 101 with the 5G network, to establish bearer channels associated with a session with UE 101, to hand off UE 101 from the 5G network to another network, to hand off UE 101 from the other network to the 5G network, manage mobility of UE 101 between RANs 610 and/or gNBs 611, and/or to perform other operations. In some embodiments, the 5G network may include multiple AMFs 615, which communicate with each other via the N14 interface (denoted in FIG. 6 by the line marked “N14” originating and terminating at AMF 615).

MME 616 may include one or more devices, systems, VNFs, CNFs, etc., that perform operations to register UE 101 with the EPC, to establish bearer channels associated with a session with UE 101, to hand off UE 101 from the EPC to another network, to hand off UE 101 from another network to the EPC, manage mobility of UE 101 between RANs 612 and/or eNBs 613, and/or to perform other operations.

SGW 617 may include one or more devices, systems, VNFs, CNFs, etc., that aggregate traffic received from one or more eNBs 613 and send the aggregated traffic to an external network or device via UPF/PGW-U 635. Additionally, SGW 617 may aggregate traffic received from one or more UPF/PGW-Us 635 and may send the aggregated traffic to one or more eNBs 613. SGW 617 may operate as an anchor for the user plane during inter-eNB handovers and as an anchor for mobility between different telecommunication networks or RANs (e.g., RANs 610 and 612).

SMF/PGW-C 620 may include one or more devices, systems, VNFs, CNFs, etc., that gather, process, store, and/or provide information in a manner described herein. SMF/PGW-C 620 may, for example, facilitate the establishment of communication sessions on behalf of UE 101. In some embodiments, the establishment of communications sessions may be performed in accordance with one or more policies provided by PCF/PCRF 625.

PCF/PCRF 625 may include one or more devices, systems, VNFs, CNFs, etc., that aggregate information to and from the 5G network and/or other sources. PCF/PCRF 625 may receive information regarding policies and/or subscriptions from one or more sources, such as subscriber databases and/or from one or more users (such as, for example, an administrator associated with PCF/PCRF 625).

AF 630 may include one or more devices, systems, VNFs, CNFs, etc., that receive, store, and/or provide information that may be used in determining parameters (e.g., quality of service parameters, charging parameters, or the like) for certain applications.

UPF/PGW-U 635 may include one or more devices, systems, VNFs, CNFs, etc., that receive, store, and/or provide data (e.g., user plane data). For example, UPF/PGW-U 635 may receive user plane data (e.g., voice call traffic, data traffic, etc.), destined for UE 101, from DN 650, and may forward the user plane data toward UE 101 (e.g., via RAN 610, SMF/PGW-C 620, and/or one or more other devices). In some embodiments, multiple instances of UPF/PGW-U 635 may be deployed (e.g., in different geographical locations), and the delivery of content to UE 101 may be coordinated via the N9 interface (e.g., as denoted in FIG. 6 by the line marked “N9” originating and terminating at UPF/PGW-U 635). Similarly, UPF/PGW-U 635 may receive traffic from UE 101 (e.g., via RAN 610, RAN 612, SMF/PGW-C 620, and/or one or more other devices), and may forward the traffic toward DN 650. In some embodiments, UPF/PGW-U 635 may communicate (e.g., via the N4 interface) with SMF/PGW-C 620, regarding user plane data processed by UPF/PGW-U 635.

UDM/HSS 640 and AUSF 645 may include one or more devices, systems, VNFs, CNFs, etc., that manage, update, and/or store, in one or more memory devices associated with AUSF 645 and/or UDM/HSS 640, profile information associated with a subscriber. In some embodiments, UDM/HSS 640 may include, may implement, may be communicatively coupled to, and/or may otherwise be associated with some other type of repository or database, such as a Unified Data Repository (“UDR”). AUSF 645 and/or UDM/HSS 640 may perform authentication, authorization, and/or accounting operations associated with one or more UEs 101 and/or one or more communication sessions associated with one or more UEs 101.

DN 650 may include one or more wired and/or wireless networks. For example, DN 650 may include an Internet Protocol (“IP”)-based PDN, a wide area network (“WAN”) such as the Internet, a private enterprise network, and/or one or more other networks. UE 101 may communicate, through DN 650, with data servers, other UEs 101, and/or to other servers or applications that are coupled to DN 650. DN 650 may be connected to one or more other networks, such as a public switched telephone network (“PSTN”), a public land mobile network (“PLMN”), and/or another network. DN 650 may be connected to one or more devices, such as content providers, applications, web servers, and/or other devices, with which UE 101 may communicate.

External devices 654 may include one or more devices or systems that communicate with UE 101 via DN 650 and one or more elements of 600 (e.g., via UPF/PGW-U 635). In some embodiments, external devices 654 may include, may implement, and/or may otherwise be associated with PCS 105 and/or APRS 301. External devices 654 may include, for example, one or more application servers, content provider systems, web servers, or the like. External devices 654 may, for example, implement “server-side” applications that communicate with “client-side” applications executed by UE 101. External devices 654 may provide services to UE 101 such as gaming services, videoconferencing services, messaging services, email services, web services, and/or other types of services. Operations described above with respect to a given external device 654 (e.g., in accordance with some embodiments) may be performed by a single device, by a cloud computing system, by one or more devices that implement a virtualized or containerized environment, a collection of devices, etc.

In some embodiments, external devices 654 may communicate with one or more elements of environment 600 (e.g., core network elements) via NEF/SCEF 649. NEF/SCEF 649 include one or more devices, systems, VNFs, CNFs, etc. that provide access to information, APIs, and/or other operations or mechanisms of one or more core network elements to devices or systems that are external to the core network (e.g., to external device 654 via DN 650). NEF/SCEF 649 may maintain authorization and/or authentication information associated with such external devices or systems, such that NEF/SCEF 649 is able to provide information, that is authorized to be provided, to the external devices or systems. For example, a given external device 654 may request particular information associated with one or more core network elements. NEF/SCEF 649 may authenticate the request and/or otherwise verify that external device 654 is authorized to receive the information, and may request, obtain, or otherwise receive the information from the one or more core network elements. In some embodiments, NEF/SCEF 649 may include, may implement, may be implemented by, may be communicatively coupled to, and/or may otherwise be associated with a Security Edge Protection Proxy (“SEPP”), which may perform some or all of the functions discussed above. External device 654 may, in some situations, subscribe to particular types of requested information provided by the one or more core network elements, and the one or more core network elements may provide (e.g., “push”) the requested information to NEF/SCEF 649 (e.g., in a periodic or otherwise ongoing basis).

In some embodiments, external devices 654 may communicate with one or more elements of RAN 610 and/or 612 via an API or other suitable interface. For example, a given external device 654 may provide instructions, requests, etc. to RAN 610 and/or 612 to provide one or more services via one or more respective MECs 614. In some embodiments, such instructions, requests, etc. may include QoS parameters, Service Level Agreements (“SLAs”), etc. (e.g., maximum latency thresholds, minimum throughput thresholds, etc.) associated with the services.

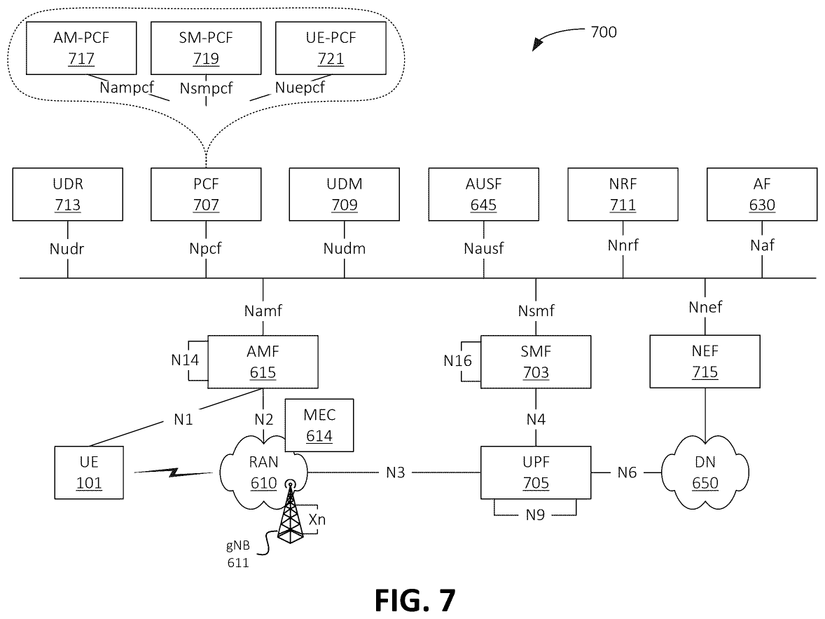

FIG. 7 illustrates another example environment 700, in which one or more embodiments may be implemented. In some embodiments, environment 700 may correspond to a 5G network, and/or may include elements of a 5G network. In some embodiments, environment 700 may correspond to a 5G SA architecture. In some embodiments, environment 700 may include a 5GC, in which 5GC network elements perform one or more operations described herein.

As shown, environment 700 may include UE 101, RAN 610 (which may include one or more gNBs 611 or other types of wireless network infrastructure) and various network functions, which may be implemented as VNFs, CNFs, etc. Such network functions may include AMF 615, SMF 703, UPF 705, PCF 707, UDM 709, AUSF 645, Network Repository Function (“NRF”) 711, AF 630, UDR 713, and NEF 715. Environment 700 may also include or may be communicatively coupled to one or more networks, such as DN 650.

The example shown in FIG. 7 illustrates one instance of each network component or function (e.g., one instance of SMF 703, UPF 705, PCF 707, UDM 709, AUSF 645, etc.). In practice, environment 700 may include multiple instances of such components or functions. For example, in some embodiments, environment 700 may include multiple “slices” of a core network, where each slice includes a discrete and/or logical set of network functions (e.g., one slice may include a first instance of SMF 703, PCF 707, UPF 705, etc., while another slice may include a second instance of SMF 703, PCF 707, UPF 705, etc.). Additionally, or alternatively, one or more of the network functions of environment 700 may implement multiple network slices. The different slices may provide differentiated levels of service, such as service in accordance with different QoS parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include interfaces shown in FIG. 7 and/or one or more interfaces not explicitly shown in FIG. 7. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 700 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 615), an Nudm interface (e.g., indicating communications to be routed to UDM 709), an Npcf interface, an Nupf interface, an Nnef interface, an Nsmf interface, an Nnrf interface, an Nudr interface, an Naf interface, and/or one or more other SBIs.

UPF 705 may include one or more devices, systems, VNFs, CNFs, etc., that receive, route, process, and/or forward traffic (e.g., user plane traffic). As discussed above, UPF 705 may communicate with UE 101 via one or more communication sessions, such as PDU sessions. Such PDU sessions may be associated with a particular network slice or other suitable QoS parameters, as noted above. UPF 705 may receive downlink user plane traffic (e.g., voice call traffic, data traffic, etc. destined for UE 101) from DN 650, and may forward the downlink user plane traffic toward UE 101 (e.g., via RAN 610). In some embodiments, multiple UPFs 705 may be deployed (e.g., in different geographical locations), and the delivery of content to UE 101 may be coordinated via the N9 interface. Similarly, UPF 705 may receive uplink traffic from UE 101 (e.g., via RAN 610), and may forward the traffic toward DN 650. In some embodiments, UPF 705 may implement, may be implemented by, may be communicatively coupled to, and/or may otherwise be associated with UPF/PGW-U 635. In some embodiments, UPF 705 may communicate (e.g., via the N4 interface) with SMF 703, regarding user plane data processed by UPF 705 (e.g., to provide analytics or reporting information, to receive policy and/or authorization information, etc.).

PCF 707 may include one or more devices, systems, VNFs, CNFs, etc., that aggregate, derive, generate, etc. policy information associated with the 5GC and/or UEs 101 that communicate via the 5GC and/or RAN 610. PCF 707 may receive information regarding policies and/or subscriptions from one or more sources, such as subscriber databases (e.g., UDM 709, UDR 713, etc.), and/or from one or more users such as, for example, an administrator associated with PCF 707. In some embodiments, the functionality of PCF 707 may be split into multiple network functions or subsystems, such as access and mobility PCF (“AM-PCF”) 717, session management PCF (“SM-PCF”) 719, UE PCF (“UE-PCF”) 721, and so on. Such different “split” PCFs may be associated with respective SBIs (e.g., AM-PCF 717 may be associated with an Nampcf SBI, SM-PCF 719 may be associated with an Nsmpcf SBI, UE-PCF 721 may be associated with an Nuepcf SBI, and so on) via which other network functions may communicate with the split PCFs. The split PCFs may maintain information regarding policies associated with different devices, systems, and/or network functions.

NRF 711 may include one or more devices, systems, VNFs, CNFs, etc. that maintain routing and/or network topology information associated with the 5GC. For example, NRF 711 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 713 may include one or more devices, systems, VNFs, CNFs, etc. that provide user and/or subscriber information, based on which PCF 707 and/or other elements of environment 700 may determine access policies, QoS policies, charging policies, or the like. In some embodiments, UDR 713 may receive such information from UDM 709 and/or one or more other sources.

NEF 715 include one or more devices, systems, VNFs, CNFs, etc. that provide access to information, APIs, and/or other operations or mechanisms of the 5GC to devices or systems that are external to the 5GC. NEF 715 may maintain authorization and/or authentication information associated with such external devices or systems, such that NEF 715 is able to provide information, that is authorized to be provided, to the external devices or systems. Such information may be received from other network functions of the 5GC (e.g., as authorized by an administrator or other suitable entity associated with the 5GC), such as SMF 703, UPF 705, a charging function (“CHF”) of the 5GC, and/or other suitable network function. NEF 715 may communicate with external devices or systems (e.g., external devices 654) via DN 650 and/or other suitable communication pathways.

While environment 700 is described in the context of a 5GC, as noted above, environment 700 may, in some embodiments, include or implement one or more other types of core networks. For example, in some embodiments, environment 700 may be or may include a converged packet core, in which one or more elements may perform some or all of the functionality of one or more 5GC network functions and/or one or more EPC network functions. For example, in some embodiments, AMF 615 may include, may implement, may be implemented by, and/or may otherwise be associated with MME 616; SMF 703 may include, may implement, may be implemented by, and/or may otherwise be associated with SGW 617; PCF 707 may include, may implement, may be implemented by, and/or may otherwise be associated with a PCRF (e.g., PCF/PCRF 625); NEF 715 may include, may implement, may be implemented by, and/or may otherwise be associated with a SCEF (e.g., NEF/SCEF 649); and so on.

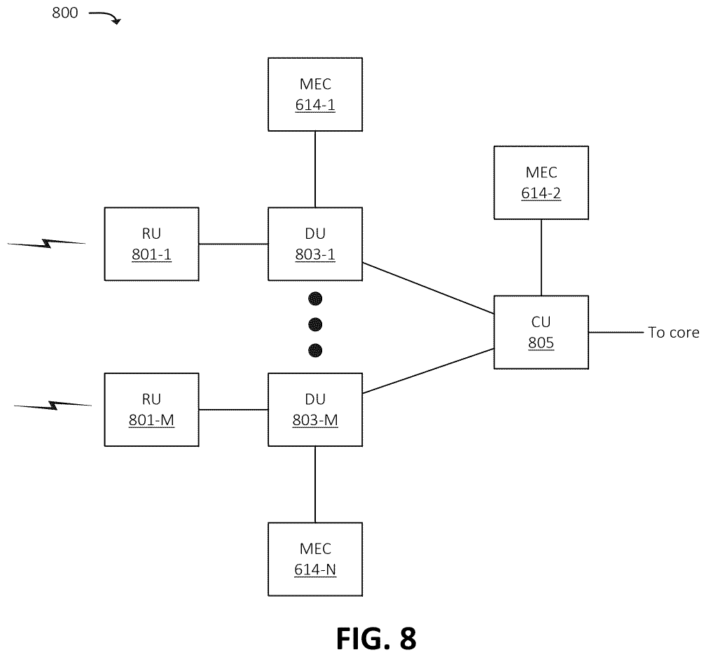

FIG. 8 illustrates an example RAN environment 800, which may be included in and/or implemented by one or more RANs (e.g., RAN 610 or some other RAN). In some embodiments, a particular RAN 610 may include one RAN environment 800. In some embodiments, a particular RAN 610 may include multiple RAN environments 800. In some embodiments, RAN environment 800 may correspond to a particular gNB 611 of RAN 610. In some embodiments, RAN environment 800 may correspond to multiple gNBs 611. In some embodiments, RAN environment 800 may correspond to one or more other types of base stations of one or more other types of RANs. As shown, RAN environment 800 may include Central Unit (“CU”) 805, one or more Distributed Units (“DUs”) 803-1 through 803-M (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 615 and/or UPF 705) and/or some other device or system such as MEC 614. In the uplink direction (e.g., for traffic from UEs 101 to a core network), CU 805 may aggregate traffic from DUs 803, and forward the aggregated traffic to the core network. In some embodiments, CU 805 may receive traffic according to a given protocol (e.g., Radio Link Control (“RLC”) traffic) from DUs 803, and may perform higher-layer processing (e.g., may aggregate/process RLC packets and generate Packet Data Convergence Protocol (“PDCP”) packets based on the RLC packets) on the traffic received from DUs 803.

CU 805 may receive downlink traffic (e.g., traffic from the core network, traffic from a given MEC 614, etc.) for a particular UE 101, and may determine which DU(s) 803 should receive the downlink traffic. DU 803 may include one or more devices that transmit traffic between a core network (e.g., via CU 805) and UE 101 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 101.

RU 801 may include hardware circuitry (e.g., one or more RF transceivers, antennas, radios, and/or other suitable hardware) to communicate wirelessly (e.g., via an RF interface) with one or more UEs 101, one or more other DUs 803 (e.g., via RUs 801 associated with DUs 803), and/or any other suitable type of device. In the uplink direction, RU 801 may receive traffic from UE 101 and/or another DU 803 via the RF interface and may provide the traffic to DU 803. In the downlink direction, RU 801 may receive traffic from DU 803, and may provide the traffic to UE 101 and/or another DU 803.

One or more elements of RAN environment 800 may, in some embodiments, be communicatively coupled to one or more MECs 614. For example, DU 803-1 may be communicatively coupled to MEC 614-1, DU 803-M may be communicatively coupled to MEC 614-N, CU 805 may be communicatively coupled to MEC 614-2, and so on. MECs 614 may include hardware resources (e.g., configurable or provisionable hardware resources) that may be configured to provide services and/or otherwise process traffic to and/or from UE 101, via a respective RU 801.

For example, DU 803-1 may route some traffic, from UE 101, to MEC 614-1 instead of to a core network via CU 805. MEC 614-1 may process the traffic, perform one or more computations based on the received traffic, and may provide traffic to UE 101 via RU 801-1. As discussed above, MEC 614 may include, and/or may implement, some or all of the functionality described above with respect to UPF 705, AF 630, and/or one or more other devices, systems, VNFs, CNFs, etc. In this manner, ultra-low latency services may be provided to UE 101, as traffic does not need to traverse DU 803, CU 805, links between DU 803 and CU 805, and an intervening backhaul network between RAN environment 800 and the core network.

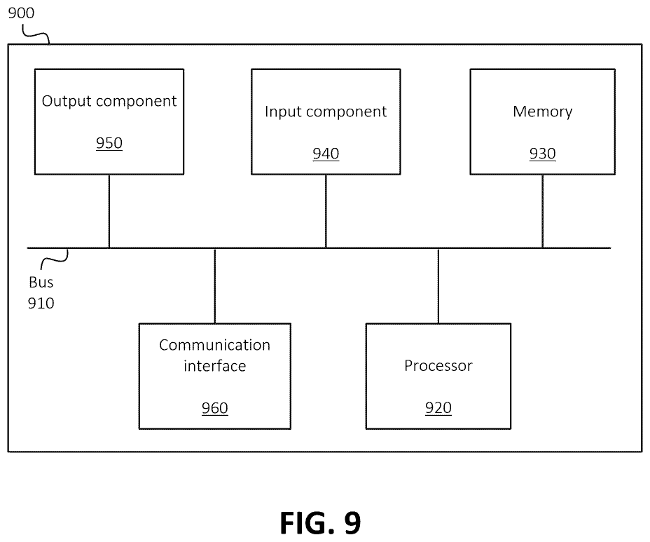

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a GPS-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems (e.g., via RAN 610, RAN 612, DN 650, etc.). For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 900 may include more than one communication interface 960. For instance, device 900 may include an optical interface, a wireless interface, an Ethernet interface, and/or one or more other interfaces.

Device 900 may perform certain operations relating to one or more processes described above. Device 900 may perform these operations in response to processor 920 executing instructions, such as software instructions, processor-executable instructions, etc. stored in a computer-readable medium, such as memory 930. A computer-readable medium may be defined as a non-transitory memory device. A memory device may include space within a single physical memory device or spread across multiple physical memory devices. The instructions may be read into memory 930 from another computer-readable medium or from another device. The instructions stored in memory 930 may be processor-executable instructions that cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a set of signals from a plurality of satellites;
determine a first set of pseudoranges based on the received set of signals, wherein each pseudorange of the first set of pseudoranges is associated with a particular satellite of the plurality of satellites;
determine a coarse location for each pseudorange, of the first set of pseudoranges, based on the first set of pseudoranges;
determine a set of correction values for each pseudorange, of the first set of pseudoranges, based on the coarse location;
apply the set of correction values to the first set of pseudoranges to obtain a second set of pseudoranges;
determine, based on one or more artificial intelligence/machine learning (“AI/ML”) models, a third set of pseudoranges based on the second set of pseudoranges;
identify a set of sensor data associated with the device;
modify the third set of pseudoranges based on the sensor data to obtain a fourth set of pseudoranges; and
determine a precise location of the device based on the fourth set of pseudoranges.

2. The device of claim 1, wherein a particular pseudorange, of the first set of pseudoranges, is based on a distance between the device and a particular satellite of the plurality of satellites.

3. The device of claim 1, wherein the one or more AI/ML models include a long-short term memory (“LSTM”) model.

4. The device of claim 1, wherein the sensor data includes at least one of:
Inertial Measurement Unit (“IMU”) data associated with the device, or
accelerometer data associated with the device.

5. The device of claim 1, wherein the device includes a User Equipment (“UE”) that is communicatively coupled to a wireless network.

6. The device of claim 1, wherein modifying the third set of pseudoranges includes performing a filtering or smoothing operation.

7. The device of claim 6, wherein the filtering or smoothing operation includes a Kalman filtering operation.

8. A non-transitory computer-readable medium, storing a plurality of processor-executable instructions to:
receive a set of signals from a plurality of satellites;
determine a first set of pseudoranges based on the received set of signals, wherein each pseudorange of the first set of pseudoranges is associated with a particular satellite of the plurality of satellites;
determine a coarse location for each pseudorange, of the first set of pseudoranges, based on the first set of pseudoranges;
determine a set of correction values for each pseudorange, of the first set of pseudoranges, based on the coarse location;
apply the set of correction values to the first set of pseudoranges to obtain a second set of pseudoranges;
determine, based on one or more artificial intelligence/machine learning (“AI/ML”) models, a third set of pseudoranges based on the second set of pseudoranges;
identify a set of sensor data associated with a device;
modify the third set of pseudoranges based on the sensor data to obtain a fourth set of pseudoranges; and
determine a precise location of the device based on the fourth set of pseudoranges.

9. The non-transitory computer-readable medium of claim 8, wherein a particular pseudorange, of the first set of pseudoranges, is based on a distance between the device and a particular satellite of the plurality of satellites.

10. The non-transitory computer-readable medium of claim 8, wherein the one or more AI/ML models include a long-short term memory (“LSTM”) model.

11. The non-transitory computer-readable medium of claim 8, wherein the sensor data includes at least one of:
Inertial Measurement Unit (“IMU”) data associated with the device, or
accelerometer data associated with the device.

12. The non-transitory computer-readable medium of claim 8, wherein the device includes a User Equipment (“UE”) that is communicatively coupled to a wireless network.

13. The non-transitory computer-readable medium of claim 8, wherein modifying the third set of pseudoranges includes performing a filtering or smoothing operation.

14. The non-transitory computer-readable medium of claim 13, wherein the filtering or smoothing operation includes a Kalman filtering operation.

15. A method, comprising:
receiving, by a device, a set of signals from a plurality of satellites;
determining a first set of pseudoranges based on the received set of signals, wherein each pseudorange of the first set of pseudoranges is associated with a particular satellite of the plurality of satellites;
determining a coarse location for each pseudorange, of the first set of pseudoranges, based on the first set of pseudoranges;
determining a set of correction values for each pseudorange, of the first set of pseudoranges, based on the coarse location;
applying the set of correction values to the first set of pseudoranges to obtain a second set of pseudoranges;
determining, based on one or more artificial intelligence/machine learning (“AI/ML”) models, a third set of pseudoranges based on the second set of pseudoranges;
identifying a set of sensor data associated with the device;
modifying the third set of pseudoranges based on the sensor data to obtain a fourth set of pseudoranges; and
determining a precise location of the device based on the fourth set of pseudoranges.

16. The method of claim 15, wherein a particular pseudorange, of the first set of pseudoranges, is based on a distance between the device and a particular satellite of the plurality of satellites.

17. The method of claim 15, wherein the one or more AI/ML models include a long-short term memory (“LSTM”) model.

18. The method of claim 15, wherein the sensor data includes at least one of:
Inertial Measurement Unit (“IMU”) data associated with the device, or
accelerometer data associated with the device.

19. The method of claim 15, wherein the device includes a User Equipment (“UE”) that is communicatively coupled to a wireless network.

20. The method of claim 15, wherein modifying the third set of pseudoranges includes performing a filtering or smoothing operation, wherein the filtering or smoothing operation includes a Kalman filtering operation.
